(19) United States
(12) Patent Application Publication
(10) Pub. No.: US 2018/0317723 A1
(43) Pub. Date: Nov. 8, 2018

(54) SYSTEM, APPARATUS, AND METHOD FOR CLEANING A HIGH RISE SURFACE

(71) Applicants: Hamed Marhi ALDHAFEERI, Wilder, KY (US); Mohammed Majed ALHAJRI, Wilder, KY (US)

(72) Inventors: Hamed Marhi ALDHAFEERI, Wilder, KY (US); Mohammed Majed ALHAJRI, Wilder, KY (US)

(21) Appl. No.: 15/586,006

(22) Filed: May 3, 2017

(51) Int. Cl. A47L 1/02; B08B 1/00; B08B 3/14

(52) U.S. Cl. CPC A47L 1/02; B08B 1/005; B08B 3/14; B08B 1/008; B08B 1/002

(57) ABSTRACT

An apparatus for cleaning a surface includes a guide track including a threaded rod mounted on a side of a window frame; a cleaning head operably attached to the guide track; and a motor for moving the cleaning head along the guide track. Wherein upon activation of the motor, the threaded rod is rotated in a first direction causing the cleaning head to move toward a first end of the threaded rod and upon reactuation of the motor, the rod is rotated in a second direction opposite to the first direction causing the cleaning head to move along the threaded rod toward a second end of the threaded rod, the second end being opposite to the first end.

### GRANT OF NON-EXCLUSIVE RIGHT

This application was prepared with financial support from the Saudia Arabian Cultural Mission, and in consideration therefore the present inventor has granted The Kingdom of Saudi Arabia a non-exclusive right to practice the present invention.

### BACKGROUND

The exterior surfaces of windows at high elevations (e.g., windows of a skyscraper) typically are cleaned by a window washer that manually cleans and washes windows. The window washer typically stands on a vertically movable scaffold suspended by cables or ropes secured to a roof of the building. The cleaning of a window involves washing usually with water and detergents which make the suspended scaffold slippery and dangerous to work on. Not only is it dangerous but it is also time consuming work. In addition, the rapid growth of skyscraper buildings resulted in a huge demand for window washers.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

The present disclosure relates to an apparatus for cleaning a surface. The apparatus includes a guide track including a threaded rod mounted on a side of a window frame; a cleaning head operably attached to the guide track; and a motor for moving the cleaning head along the guide track. Wherein upon activation of the motor, the threaded rod is rotated in a first direction causing the cleaning head to move toward a first end of the threaded rod and upon reactuation of the motor, the rod is rotated in a second direction opposite to the first direction causing the cleaning head to move along the threaded rod toward a second end of the threaded rod, the second end being opposite to the first end.

The foregoing paragraph has been provided by way of general introduction, and is not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration view of a cleaning apparatus positioned on the exterior of a structure according to one example;

FIG. 2 is a front view of the cleaning apparatus positioned within a window frame according to one example;

FIG. 3 is a front view of the cleaning apparatus positioned within the window frame according to another example; and

FIG. 4 is an exploded view of a cleaning head of the cleaning apparatus.

### DETAILED DESCRIPTION

Referring now to the drawings, wherein like reference numerals designate identical or corresponding parts throughout several views, the following description relates to a cleaning apparatus and associated methodologies for cleaning a high rise surface, for example, windows.

Windows of buildings require cleaning frequently, for example, every month. Manually cleaning the windows is costly and time consuming. In addition, the work is dangerous. Described herein is a cleaning apparatus that is easily installed and provides a permanent solution for window cleaning.

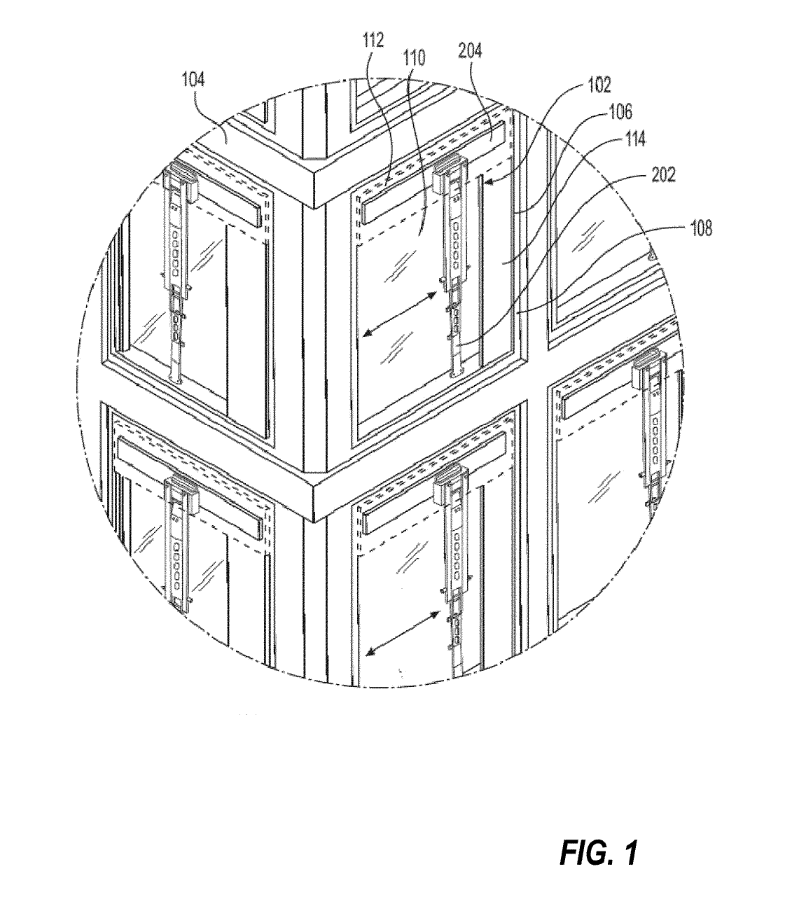

FIG. 1 is an illustration view of a cleaning apparatus 102 positioned on the exterior of a structure 104 (e.g., building) according to one example. The cleaning apparatus 102 is used to clean the exterior of a window 106. The window 106 may include a window frame 108 and a window pane 110. The cleaning apparatus 102 may be mounted within the window frame 108 of the structure 104. The cleaning apparatus 102 may include a cleaning head 202 and a guide track 204. The guide track 204 is positioned to extend horizontally along a top end of window frame 108. The cleaning head 202 is mounted on the guide track 204. Positioned at the top end of the window frame 108 is a panel 112 for hiding the guide track 204 of the cleaning apparatus 102. Positioned at a side end of the window frame is a second panel 114 for hiding the cleaning head 202 of the cleaning apparatus 102 when not in use. Panels 112,114 function to protect an operating mechanism of the cleaning apparatus 102 when not in use.

In FIG. 1, the guide track 204 and the panel 112 are shown positioned at the top end of the window frame 108. Such position is illustrated for purposes of example only. Alternatively, the panel 112 and the guide track 204 may be positioned at a bottom end of the window frame 108. In addition, positioning the guide track 204 horizontally thereby causing the cleaning head 202 to move horizontally along the window pane 110 (e.g., surface of the window) is shown for purposes of example only. Alternatively, the guide track 204 can be positioned along the vertical side of the window frame 108 thereby causing the cleaning head 202 to move vertically over the surface of the window 106.

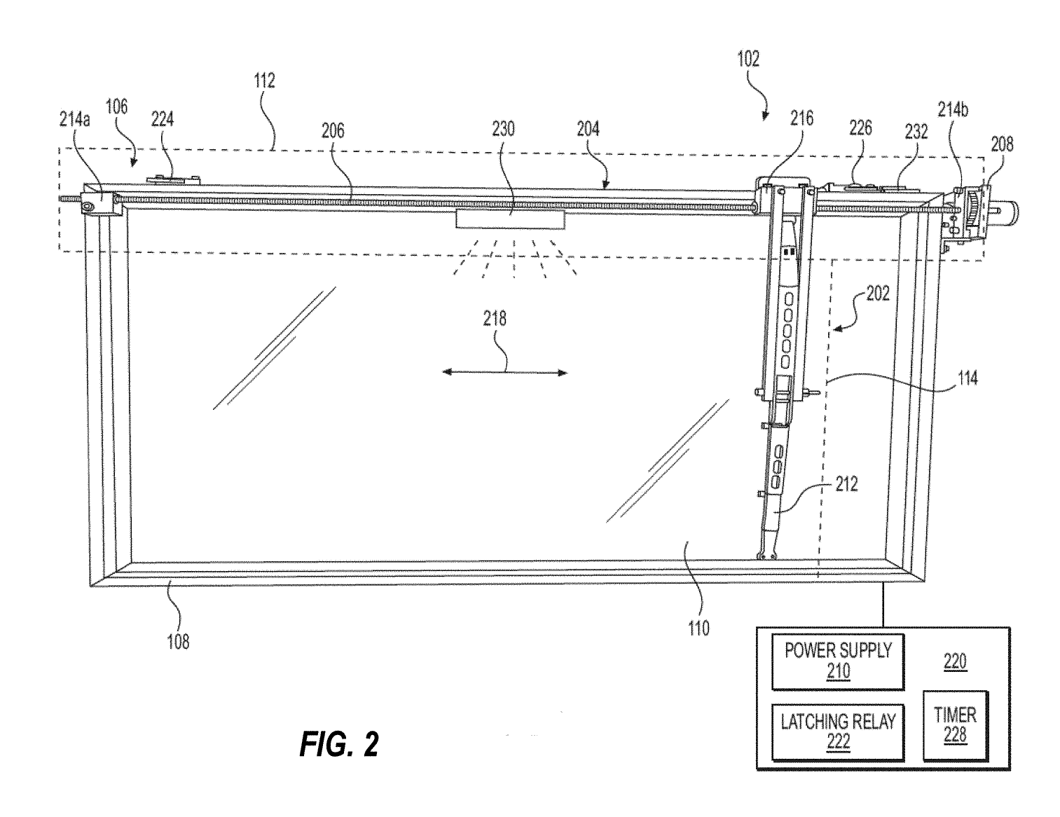

FIG. 2 is a front view of the cleaning apparatus 102 positioned within the window frame 108 according to one example. FIG. 2 shows a single window frame 108. FIG. 2 shows the panel 112 and the second panel 114 in phantom. The guide track 204 may include a threaded rod 206 (i.e., lead screw). The threaded rod 206 is mounted along the top end of the window frame 108 of the window 106. The threaded rod 206 is fixed between two bearing bases 214a, 214b in parallel to the top end of the window frame 108. The two bearing bases 214a, 214b are attached to the window frame 108 proximate to a top right corner and a top left corner of the window frame 108, respectively. The threaded rod 206 may be of a length substantially equal to the top end of the window frame 108.

The cleaning apparatus 102 may include a motor 208. The motor 208 may be a reversible drive DC motor which is operably connected to a rechargeable battery or a power supply 210. The rechargeable battery may be a solar rechargeable battery electrically communicating with a solar cell that is disposed at the window frame 108 and charges the solar rechargeable battery. The speed of the motor 208 may be controlled by a controller (not shown). The motor 208 may have an axis of the motor 208 parallel to the threaded rod 206.

The cleaning head 202 is generally elongate and carries a wiper blade 212. The cleaning head 202 has a nut 216 engaged with the threaded rod 206. The nut 216 is attached coaxially with an axis of the threaded rod 206. The threaded engagement between the nut 216 and the threaded rod 206 transfers a rotary movement of the threaded rod 206 into an axial movement along the threaded rod 206 in an axial direction 218. The motor 208 can rotate the threaded rod 206 in either direction (i.e., clockwise or counter-clockwise) such that the nut 216 can slide along the threaded rod 206 causing the cleaning head 202 and therefore the wiper blade 212 to move in the axial direction 218. In other words, the cleaning head 202 may move forward and backward in the axial direction 218.

In one aspect, the wiper blade 212 may be of a shape and size depending on the shape and size of window 106. A length of the wiper blade 212 may be adjustable. For example, the length may be automatically adjusted when the cleaning head 202 is moving across the threaded rod 206 when the shape of the window is non-rectangular (e.g., circular, oval) to cover the window pane 110. The wiper blade 212 can be replaced with a roller covered with an absorbent material that absorbs water from the surface of the window pane 110.

The cleaning apparatus 102 may also include a latching relay 222 (e.g., a coil relay) having two or more contact positions (e.g., a first position and a second position). The cleaning apparatus 102 includes a first switch 224 with an external lever (or actuator) positioned approximate to a first end of the threaded rod 206 and a second switch 226 with an external lever positioned approximate to a second end of the threaded rod 206.

When the nut 216 reaches one end of the threaded rod 206 causing one of the first switch 224 or the second switch 226 to close which actuates the latching relay 222 by changing a contact position of the latching relay 222 and consequently causes the motor 208 to change a rotating direction, resulting in the nut 216 changing its sliding direction.

In one example, the cleaning apparatus 102 may also include a timer 228 or a time delay circuit. The timer 228 may delay activating the power supply 210 (e.g., 12-28 Volt) associated with the motor 208 when the latching relay 222 changes a current contact position to another contact position. Thus, the nut 216 halts and therefore the cleaning head 202 at an end of the threaded rod 206 until the delay is over. The delay may be preset for two seconds or other suitable period based on a mode of operation of the cleaning apparatus 102.

The cleaning apparatus 102 may include a pump 230. In one implementation, the pump 230 is activated via the power supply 210 when the latching relay 222 changes contact positions. The pump 230 is configured to spray a cleaning fluid to the window pane 110. The cleaning fluid can be any appropriate cleaning fluid. The pump 230 may include a nozzle sprayer. The pump 230 is coupled to a supply of the cleaning fluid by fluid conduits (not shown).

In one example, the pump 230 may be positioned in a middle section of the top end of the window frame 108. For example, the pump 230 may be positioned at equidistant from the two ends of the guide track 204 enclosed by the panel 112. This has the advantage of the ability to spray the cleaning fluid over the entire window pane 110 while being protected from elements such as dirt particles, rain, or dust. In one example, the cleaning head 202 may include the pump 230. The nozzle sprayer may be rotatable such that when activated the nozzle sprayer scans substantially the whole window surface during the delay. The delay may be a function of the time required by the nozzle spray rotation speed.

The pump 230 may also be configured to spray water. Water can be supplied from a water source (e.g., a water line of the structure 104 on which one or more cleaning apparatus 102 are installed). Water and cleaning fluid can be supplied to the cleaning apparatus 102 from a tank or storage vessel (not shown) located near the cleaning apparatus 102 or at a remote location.

The cleaning apparatus 102 may include a third switch 232 with an external lever proximate to the second switch 226. The third switch 232 may control the power supply to the pump 230. The third switch 232 is configured to be in an open position when the nut 216 leaves the first end of thread rod 206 after the delay, thus stopping an operation of the pump 230. For example, when the cleaning head 202 loses mechanical contact with the third switch 232 and the second switch 226, the switches 226, 232 are released which causes the pump 230 to turn off.

One or more parts of the cleaning apparatus 102 may be positioned (e.g., attached, secured) on the window frame 108 (e.g., motor, switches). Other electric components may be installed on an electrical panel 220 located near the window 106 or at a remote location.

The cleaning apparatus 102 may be activated remotely or by pressing a push button (not shown). The electrical panel 220 may include the power supply 210, the latching relay 222, and the timer 228.

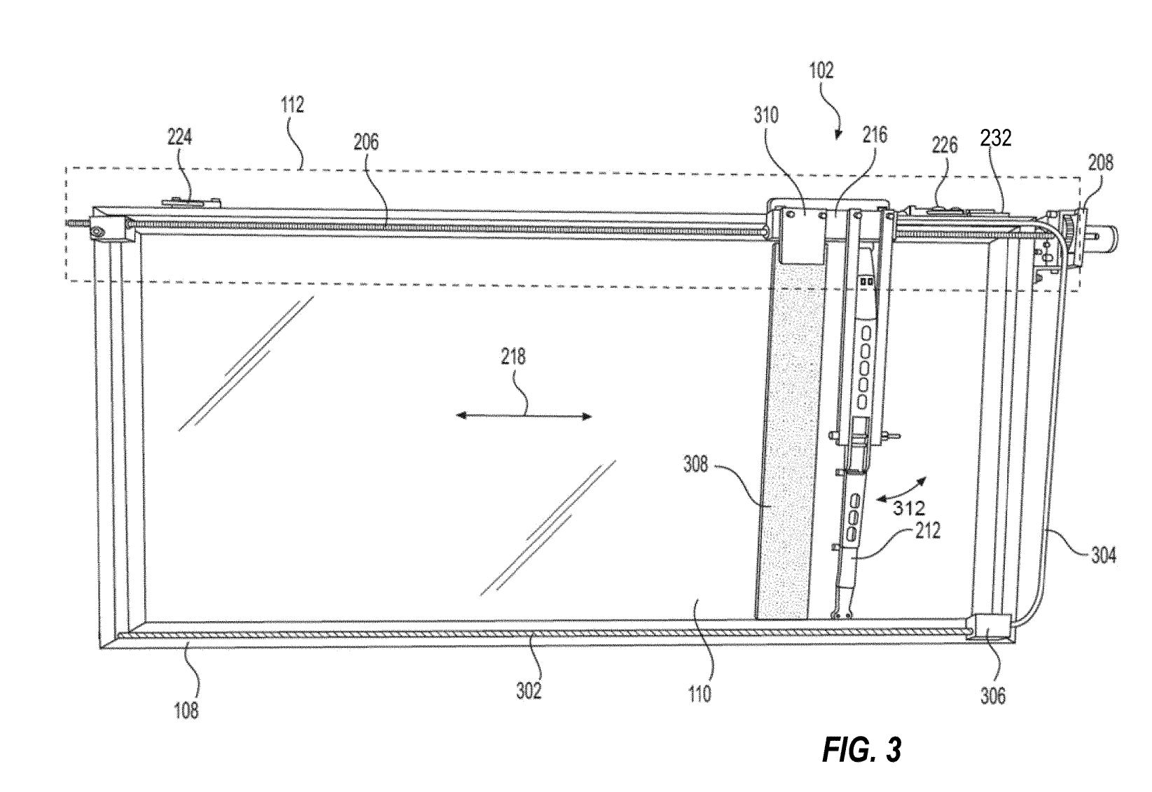

The cleaning head 202 may also carry a brush 308 which extends next to the wiper blade 212 as shown in FIG. 3. The brush 308 can be formed from suitable material such as sponge or bristles. In one implementation, the brush 308 can be replaced by a rotating brush that is supported for rolling contact on the window pane 110.

In one implementation, a bottom end of the window frame 108 may include a conduit 302 configured to collect waste fluid (e.g., water, cleaning fluid) from the cleaning process. The conduit 302 having a first end and a second end. The first end of the conduit 302 is raised above the second end of the conduit 302. In other words, the conduit 302 is inclined toward a bottom corner of the window frame 108. The conduit may have a perforated cover. The conduit 302 may be connected to a tube 304 connected to a filtration system configured to filter the collected waste fluid so that the filtered waste fluid may be reused by the cleaning apparatus 102 or to other functions such as irrigation. The filtration system may include a filter 306 which is used to filter the waste fluid collected by the conduit 302. The filter 306 may be positioned at an end of the conduit 302, below the second panel 114, for example. The tube 304 may be connected to the cleaning head 202. The tube 304 may be a flexible expandable tube that is operable to expand when the cleaning head 202 is moving along the guide track 204.

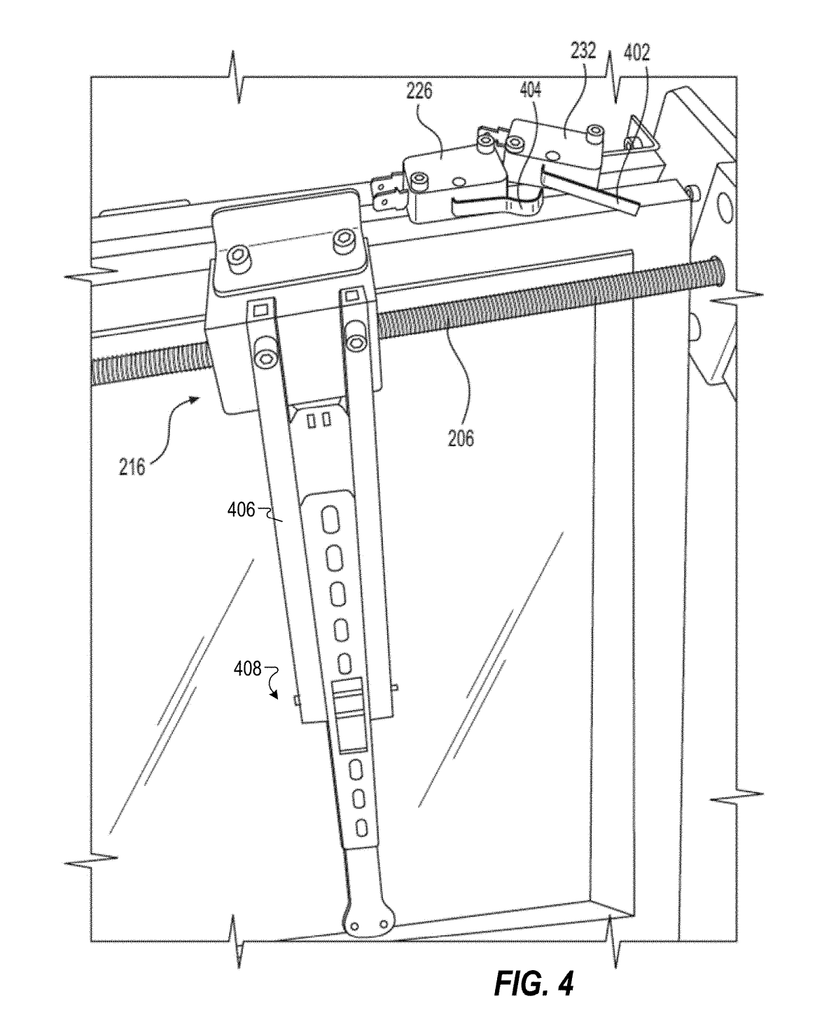

FIG. 4 shows an exploded view of a section of the cleaning apparatus 102. The second switch 226 includes an external lever 404. The third switch 232 includes another external lever 402.

The cleaning head 202 may include a wiper frame 406. The wiper blade 212 may be attached to the wiper frame 406 via connection points 408. The wiper frame 406 may be made of any rigid material such as metal or plastic. The location of the connection points 408 may vary in different embodiments. The wiper frame 406 is attached to the nut 216. The wiper blade 212 may be made of a rubber material.

In one aspect, the wiper blade 212 may be rotatable about a pivot bar (not shown) associated with the wiper frame 406 to allow rotation of the wiper blade 212 relative to the wiper frame 406.

Each cleaning apparatus 102 is selectively operable from within the structure 104 thereby allowing a user to selectively determine when the exterior of the window is to be cleaned. Alternatively, the cleaning apparatus 102 may be activated at preset time intervals (e.g., every month, every week) by the controller.

The controller may activate/deactivate the cleaning apparatus 102 based on information stored in a database such as building data, window data, and nozzle spray data. The window data may include information associated with each cleaning apparatus 102 for each window 106. The information may indicate a usage count for wiper blade 212 which indicates when the wiper blade or other parts of the cleaning apparatus has to be replaced. The nozzle spray data may include a status of cleaning fluid in each of the cleaning apparatus 102 that may indicate whether the cleaning fluid has to be refilled.

A system which includes the features in the foregoing description provides numerous advantages to users. In particular, the window cleaning apparatus described herein provides a safe and economical way to clean windows of tall buildings. In addition, the apparatus described herein reduces water consumption because the water is being recycled.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. An apparatus for cleaning a surface, comprising:
a guide track including a threaded rod mounted on a side of a window frame;
a cleaning head operably attached to the guide track;
a motor configured to move the cleaning head along the guide track; and
wherein upon activation of the motor, the threaded rod is rotated in a first direction causing the cleaning head to move toward a first end of the threaded rod and upon reactuation of the motor, the rod is rotated in a second direction opposite to the first direction causing the cleaning head to move along the threaded rod toward a second end of the threaded rod, the second end being opposite to the first end.

2. The apparatus of claim 1, wherein the cleaning head includes a wiper blade.

3. The apparatus of claim 2, wherein a length of the wiper blade is adjustable.

4. The apparatus of claim 3, wherein the cleaning head includes a brush.

5. The apparatus of claim 1, wherein the cleaning head is attached to the threaded rod using a nut configured to transfer a rotary movement of the threaded rod into an axial movement along the threaded rod.

6. The apparatus of claim 4, wherein the cleaning head includes a nozzle spray configured to spray cleaning fluid on a window pane.

7. The apparatus of claim 6, wherein:
the nozzle spray is positioned at a top end of the window frame.

8. The apparatus of claim 7, further comprising:
a first switch with an external lever positioned at the first end or the second end of the threaded rod, wherein the nozzle spray is activated when the first switch is closed, the first switch being closed when the cleaning head comes into mechanical contact with the external lever.

9. The apparatus of claim 1, further comprising:
a conduit positioned at a bottom end of the window frame to collect waste liquid, the conduit having a first end and a second end, wherein the first end is raised above the second end in a vertical direction.

10. The apparatus of claim 9, further comprising:
a filtration system positioned at the second end of the conduit and configured to filter the waste liquid collected by the conduit.

11. The apparatus of claim 10, further comprising:
a tube having a first end connected to the filtration system and a second end connected to a nozzle spray configured to spray the filtered waste liquid.

12. The apparatus of claim 1, further comprising:
a relay operably attached to the motor;
a first switch with an external lever positioned at the first end of the threaded rod;
a second switch with an external lever positioned at the second end of the threaded rod; and
wherein in response to the first switch or second switch being closed the relay is actuated which causes the motor to change a rotation direction.

13. The apparatus of claim 12, wherein the first switch closes when the cleaning head comes into mechanical contact with the external lever of the first switch, and the second switch closes when the cleaning head comes into mechanical contact with the external lever of the second switch.

14. The apparatus of claim 1, further comprising:
a first panel positioned at the top end of the frame to enclose and cover the guide track; and
a second panel positioned at a side end of the frame to enclose and cover the motor and the cleaning head when not in use.

15. The apparatus of claim 1, further comprising:
a timer configured to delay the activation of the motor, wherein the timer is activated when the cleaning head reaches the first end or the second end of the threaded rod.

16. The apparatus of claim 1, wherein the threaded rod is mounted on a top end of the window frame, between two bearings positioned at each distal end of the threaded rod and attached to the window frame.

17. A window comprising:
a window frame;
a guide track including a threaded rod mounted on a side of the window frame;
a cleaning head operably attached to the guide track;
a motor for moving the cleaning head along the guide track; and
wherein upon activation of the motor the threaded rod is rotated in a first direction causing the cleaning head to move toward a first end of the threaded rod and upon reactivation of the motor, the rod is rotated in a second direction opposite to the first direction causing the cleaning head to move along the threaded rod toward a second end of the threaded rod, the second end being opposite to the first end.

18. The window of claim 17, wherein the cleaning head includes a wiper blade.

19. The apparatus of claim 18, wherein a length of the wiper blade is adjustable.

20. The apparatus of claim 19, wherein the cleaning head includes a brush.
